(19) United States
(12) Patent Application Publication
(10) Pub. No.: US 2025/0322374 A1
(43) Pub. Date: Oct. 16, 2025

(54) TOOLS FOR LARGE LANGUAGE MODEL AGENTS

(71) Applicant: Wells Fargo Bank, N.A., San Francisco, CA (US)

(72) Inventors: Alazare Tsegaye Bati, Charlotte, NC (US); Michael Paul Bortis, Tustin, CA (US); Austin Lee Grelle, Riverside, IL (US); Guangcao Ji, Plano, TX (US); Carlton Jay Lindgren, JR., Denver, CO (US); Winthrop Treynor Smith, Littleton, CO (US); Ronald Louis Sobey, Porter, TX (US)

(21) Appl. No.: 18/633,227

(22) Filed: Apr. 11, 2024

(51) Int. Cl. G06Q 20/10; G06Q 20/38

(52) U.S. Cl. CPC G06Q 20/108; G06Q 20/382

(57) ABSTRACT

An example computer system for providing one or more tools for large language model agents can include: one or more processors; and non-transitory computer-readable storage media encoding instructions which, when executed by the one or more processors, causes the computer system to: authenticate a user; provide a description of the one or more tools available for use by the large language model agents; execute the one or more tools upon receipt of a request from the large language model agents; and provide information in response to the request.

### BACKGROUND

The venues through which customers have interacted with financial institutions have evolved over the years to include in-branch interactions, banking-by-mail, internet banking, and most recently mobile banking. There is now much public excitement around generative Artificial Intelligence (AI) products. However, federal regulators and management across the financial services industry are mandating a more cautious approach. The main concern centers around controlling “factualness” and reining in “hallucinations,” which are risks with generative AI tools, such as Large Language Models (LLMs), multi-modal models, and agent-based LLMs.

### SUMMARY

Examples provided herein are directed to tools for Large Language Model agents.

According to one aspect, an example computer system for providing one or more tools for large language model agents can include: one or more processors; and non-transitory computer-readable storage media encoding instructions which, when executed by the one or more processors, causes the computer system to: authenticate a user; provide a description of the one or more tools available for use by the large language model agents; execute the one or more tools upon receipt of a request from the large language model agents; and provide information in response to the request.

According to another aspect, an example method for providing one or more tools for large language model agents, the method comprising: authenticating a user; providing a description of the one or more tools available for use by the large language model agents; executing the one or more tools upon receipt of a request from the large language model agents; and providing information in response to the request.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for providing tools for Large Language Model agents.

FIG. 2 shows example logical components of a server device of the system of FIG. 1.

FIG. 3 shows example logical components of a client device of the system of FIG. 1.

FIG. 4 shows example physical components of the server device of FIG. 2.

### DETAILED DESCRIPTION

This disclosure relates to tools for Large Language Model (LLM) agents.

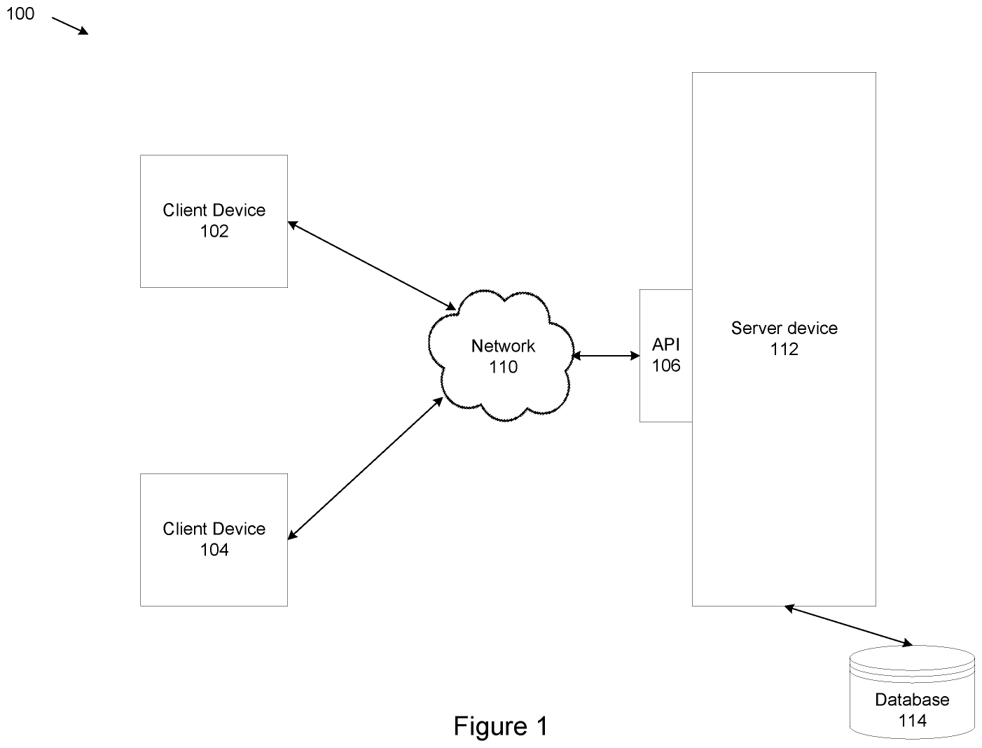

FIG. 1 schematically shows aspects of one example system 100 programmed to provide LLM agents. In this example, the system 100 can be a computing environment that includes a plurality of client and server devices. In this instance, the system 100 includes client devices 102, 104, a server device 112, and a database 114. The client devices 102, 104 can communicate with the server device 112 through a network 110 and associated application programming interface (API) 106 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client devices 102, 104 can be programmed to communicate with the server device 112 to perform various tasks, such as financial transactions. Many other configurations are possible, and the disclosure is not limitation to the financial industry.

The example client devices 102, 104 can be used by customers and/or team members of the financial institution to perform various tasks. For instance, a team member of the financial institution can use the client device 102 to perform tasks such as access financial settings and documents, transactional accounts, etc. Similarly, a customer of the financial institution can use the client device 104 to perform such tasks.

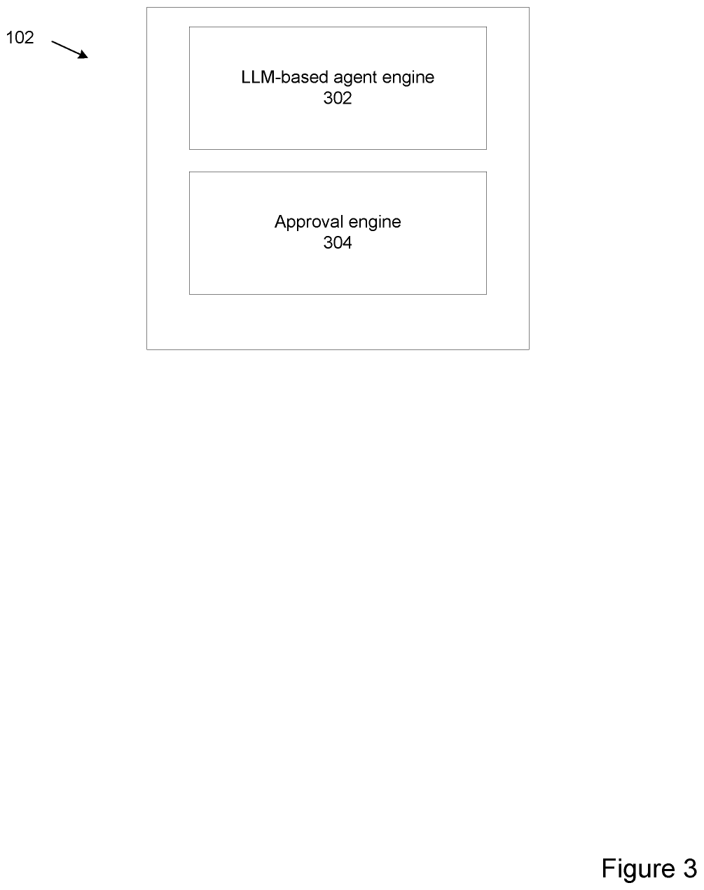

In some examples, the client devices 102, 104 execute and/or provide access to one or more chat-based LLMs, such as ChatGPT and Google Bard. More specifically, the client devices 102, 104 provide LLM-based agents (e.g., see LLM-based agent engine 302 of FIG. 3), as described further below. Many other embodiments are possible.

The example server device 112 is programmed to provide financial services functionality. Examples of such functionality include, without limitation, access to financial accounts and information. In addition, the server device 112 provides tools for use by the LLM-based agents of the client devices 102, 104, as described further below.

The example database 114 is programmed to store data associated with the financial institution that can be accessed by the server device 112. Such data includes the financial accounts of the customers of the financial institution. The database 114 can also store data associated with one or more tools implemented by the system 100.

The network 110 provides a wired and/or wireless connection between the client devices 102, 104, and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

In the examples provided herein, the client devices 102, 104 communicate with the server device 112 through the API 106 to access one or more tools that can be used by LLM-based agents. These LLM-based agents are programmed as autonomous Artificial Intelligence (AI) agents that can interact with customer's financial accounts on behalf of the customer and make authorized changes as the customer.

As provided herein, an “agent” is an autonomous AI entity that is responsible for deciding the steps to take for a given task. The agent is powered by a LLM (e.g., LLM-based agent engine 302) and is programmed to receive a prompt. The prompt contains information regarding tools that the agent can use. Such tools can be varied, including examples like calculators, web searching, scripting (e.g., Python code generation and execution), communication tools (e.g., Gmail toolkit), database queries (e.g., SQL database access), custom tools, etc.

In the examples provided below, functions and descriptions are exposed by the API 106 as “tools” available for the LLM-based agent to use in a secure and efficiency manner. Such tools can cover a wide range of banking and financial service operations that a user would routinely interact with over other banking venues be it in-person or online. LLM-based agents can chain together multiple tools to solve complex problems, possibly over extended periods of time. More specifically, the LLM is used as a reasoning engine to determine which actions to take and in which order. One non-limiting example of a technology that provides such reasoning in the context of LLMs is LangChain from LangChain, Inc., which can be used to define workflows implemented by LLMs. Additional details regarding the LLM-based agents are provided below.

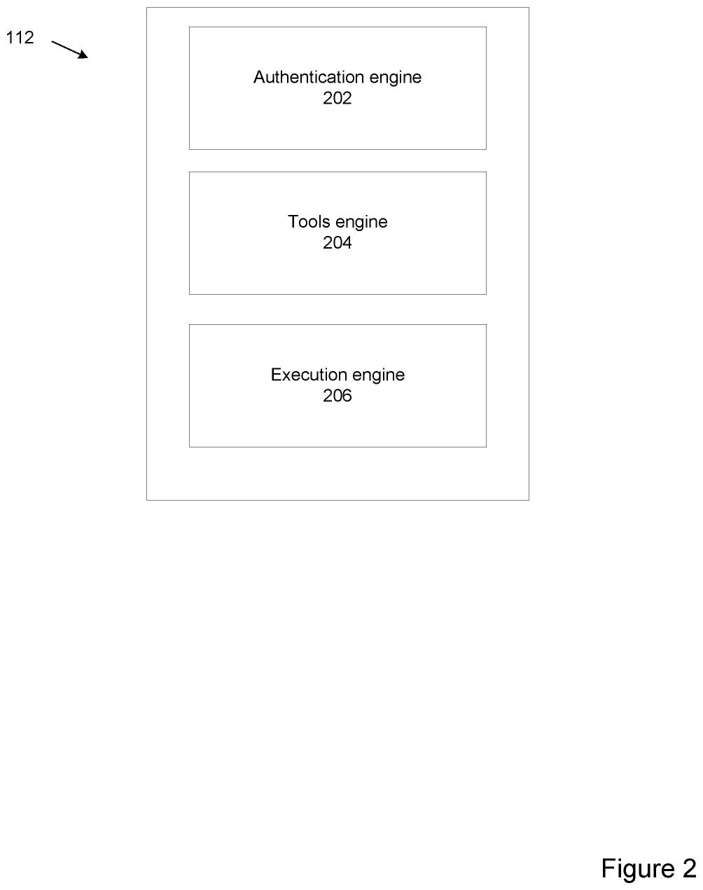

Referring now to FIG. 2, additional details of the server device 112 are shown. In this example, the server device 112 has various logical modules that assist in providing tools for the LLM-based agents. The server device 112 can, in this instance, include an authentication engine 202, a tools engine 204, and an execution engine 206. In other examples, more or fewer engines providing different functionality can be used.

The example authentication engine 202 allows the client devices 102, 104 to access the server device 112 through the API 106 in a secure manner. In some examples, the API 106 can utilize proprietary or third party services to authenticate the client devices 102, 104 before access is given. For instance, in one example, a third party service like Plaid by Plaid Inc. is used to authenticate the client device 102 before access is given to financial information stored in the database 114 of the system 100.

In one example that follows, a customer of the financial institution uses the client device 102 to request the balance of the customer's checking account. To do so, the client device 102 makes the request through an LLM-based agent to the server device 112.

Preliminarily, the financial institution verifies that the LLM-based agent is acting on behalf of user. The LLM-based agent can be linked to various chatbots that provide AI services, such as Fargo from Wells Fargo Bank, ChatGPT, Google Bard, etc.

Initially, the client device 102 can provide bank account credentials to the API 106 to access the server device 112. The authentication engine 202 of the server device 112, either internally or through a third party service provider, authenticates the user. This authentication can be accomplished through various routes, including passwords and multifactor authentication, along with such security mechanisms like POST, OAuth, etc. Upon authentication, the server device 112 provides a client key and permissions in response to the authentication request.

An example response to an authentication request by the client device 102 through the API 106 follows, which defines an authentication key (e.g., “123xc321q3”) and various features that are available to the client device 102, such as the customer settings and a balance for a checking account associated with the customer.
{
   “auth”: “123xc321q3”,
   “available features”: [
      {
         “Customer Settings”: [
         “Name”,
         “Address”
         ]
      },
      {
         “Checking Account”: [
         “Current Balance”
         ]
      }
   ]
}

Once authenticated, the client device 102 can access a series of tools available from the server device 112. In one example, the client device 102 can query the tools engine 204 of the server device 112 to request a list of the tools available to the client device 102 (e.g., specifically available to the LLM-based agent engine 302). An example response by the tools engine 204 to such a request follows.
{
   “tools”: [
      {“name”: “ListAccountTool”,
         “description”: “Provides a list of all accounts where each account has a name and a description.”},
      {“name”: “AccountBalanceTool”,
         “description”: “Useful for when you need to know the present or past balance.”},
      “ . . . ”
   ]
}

In this example, the tools engine 204 provides two tools for use by the LLM-based agent engine 302 of the client device 102, including a “ListAccountsTool” that provides a list of all accounts and an “AccountBalanceTool” that provides a present or past balance for a financial account.

The client device 102 can use the information about the tools available from the server device 112 to request details about one or more of the desired tools. For instance, the client device 102 can request additional information about the AccountBalanceTool from the server device 112. In response, the tools engine 204 provides the additional detail as follows.
{
   “tool”: “AccountBalanceTool”,
   “description”: “Useful for when you need to know the present or past balance.”,
   “fields”: [
      {“account_name”:
         “Account Name to query, for example \“Checking Account\””},
      {“context”:
         “Optional value for a point in time in the past. If not supplied will default to \“now\”.”}
   ]
}

In this example, the tools engine 204 provides additional details about the AccountBalanceTool, including the fields associated therewith, including an “account_name” field that is the account name (e.g., “Checking Account”) and a “context” field that allows for the definition of a point in time (which defaults to now if left blank).

Having a detailed understanding of the AccountBalanceTool, the LLM-based agent on the client device 102 can thereupon make a request to the server device 112 through the API 106. In one example, this request follows.
{
   “auth”: “123xc321q3”,
   “Action”: [
      {
         “action”: “AccountBalanceTool”,
         “account_name”: “Checking Account”,
         “context”: “now”
      }
   ]
}

The request includes the authentication key (“123xc321q3”), the action identifying the desired tool (“AccountBalanceTool”), and the details associated with the tool (account name (“Checking Account”) and time period (“now”).

The execution engine 206 of the server device 112 receives the request from the client device 102 through the API 106. The execution engine 206 is programmed to engage the desired tool and provide a response, an example of which follows.
{
   “Results”: [
      {
         “value”: “$9,456.12”
      }
   ]
}

The execution engine 206 provides the result back to the client device 102. In this example, the result is the current value of the Checking Account (“$9,456.12”) as defined in the request by the client device 102.

A complete example of an LLM-based agent tool as executed by the execution engine 206 follows.
from pydantic import BaseModel, Field
from langchain.tools.base import BaseTool
from typing import Optional, Type
from langchain.callbacks.manager import (
AsyncCallbackManagerForToolRun,
CallbackManagerForToolRun,
)
import datetime
import requests
import json
class AccountBalanceInput (BaseModel):
   account_name: str=Field (description=′Account Name to query, for example “Checking Account”)
   context: datetime.datetime=Optional [
   Field (description=‘Optional value for a point in time in the past. If not supplied, will default to “now”.’)]
class AccountBalanceTool (BaseTool):
   name=“AccountBalance”
   description=“Useful for when you need to know the present or past balance.”
   args_schema: Type[BaseModel]=AccountBalanceInput
   return_direct: bool=True
def_run (
   self, account_name: str, when: datetime.datetime=None,
   run_manager: Optional[CallbackManagerForToolRun]=None
   )->str:
   “““Use the tool.”””
   response=requests.post(
   https://domain.net/agents/account_balance’, {
   ‘auth’: AUTH_KEY,
   ‘Action’: {
      ‘action_target’: account_name,
      ‘action’: ‘check_account_balance’,
      ‘context’: when if when else ‘now’,
      }
   })
return json.loads (response.content)

Other examples are possible using the examples above.

For instance, the customer may wish to change the monthly payment due date on a credit card account to align with the due date for payment on a mortgage. Using the LLM-based agent engine 302 (see FIG. 3), the client device 102 communicates with the server device 112 through the API 106 to allow the LLM-based agent on the client device 102 to identify the tools that are available and string those tools together in a sequence to allow the desired outcome to occur: (i) use tool to determine the due date for mortgage payments; (ii) use tool to determine the due date for the credit cards payments; (iii) if the two do not match, use tool to request payment due date change for the credit card payments to match the mortgage payments. This can all be accomplished through the LLM-based agent on the client device 102 communicating with the server device 112 through the API 106.

In yet another example, the customer wants to make a large purchase, such as buying a vehicle. However, the customer is unsure if she could afford the down payment and the loan. The LLM-based agent engine 302 is able to use tools provided by the server device 112 to access her typical spending patterns from her banking history through on the server device 112. The customer's banking history is then used along with information about the loan costs (e.g., interest rates and other loan terms) by the LLM-based agent engine 302 to provide the customer with an understanding of the affordability of the vehicle.

Referring now to FIG. 3, example logical components of the client device 102 are shown. In this example, the client device 102 includes the LLM-based agent engine 302 and an approval engine 304. The client device 104 can be similarly configured.

As described in detail above, the LLM-based agent engine 302 is programmed to implement one or more LLM-based agents that access the tools provided by the server device 112. In some examples, the LLM-based agent engine 302 is executed on the client device 102 and/or on another computing device, such as the server device 112 or a third party server. Many configurations are possible.

The approval engine 304 of the client device 102 is programmed to mitigate some of the risks associated with the use of LLM-based agents, such as the LLM-based agent engine 302. While the approval engine 304 is shown as being executed by the client device 102, in alternative embodiments a portion or all of the functionality of the approval engine 304 can be executed by another computing device, such as the server device 112 or a third party server.

In this example, the approval engine 304 is programmed to set limits on the processes initiated by the LLM-based agent engine 302 to mitigate potential issues associated with the use of an LLM-based agent, such as hallucinations (e.g., responses that are nonsensical, factually incorrect, or disconnected form the input prompt). To do so, the approval engine 304 is programmed to intercept calls made by the LLM-based agent engine 302 and potentially require approval before data is obtained by and/or results are reported by the LLM-based agent engine 302.

In this example, the approval engine 304 intercepts all key input and output calls by the LLM-based agent engine 302 and injects additional behavior (“middleware”) or wholly replaces functionality with appropriate error messages that are then consumed by the LLM-based agent engine 302.

For example, assume the example above where the customer wishes to align the credit card payment due date with the mortgage payment due date. The LLM-based agent engine 302 accesses the tools on the server device 112 to request the payment due dates and calculate the change to the credit card payment due date. However, before the LLM-based agent engine 302 is allowed to request the modification of the credit card payment due date, the approval engine 304 intercepts the request by the LLM-based agent engine 302 and requires approval by the customer.

In one example, this may include generation of a “pop-up” approval dialog (or other control mechanism) listing details about the potential change to the credit card payment due date:
Your agent proposes to change your credit card payment due date to January 1 to align with your mortgage payment due date. Do you wish to make this change?

The customer can then approve or disapprove of the change before the LLM-based agent engine 302 is allowed to proceed with then change. If approved by the customer, the LLM-based agent engine 302 continues to use the tools provided by the server device 112 to effectuate the change. If not approved by the customer, the LLM-based agent engine 302 generates an error indicating that the change cannot be made.

In some examples, the approval engine 304 is programmed to require approval for some actions performed by the LLM-based agent engine 302, such as those impacting certain aspects of the customer (e.g., requests that involve certain monetary amounts). Other actions that might require approval are those more sensitive in nature (e.g., changes to privacy settings) and/or are known to involve areas where issues can be typical (e.g., hallucinations are known to occur).

In other examples, support personnel can monitor the status of the LLM-based agent engine 302 based on logs and artifacts it produces. In such a scenario, the LLM-based agent engine 302 may have limited or no access to write to production databases (e.g., database 114), but instead produce files (artifacts) that can be consumed by a non-agent-based processes (a normal service running a normal non-agent based programming environment), where the non-agent processes can include various functionality such as controls and checks on the data, notification of human support personnel about the status of the mail, and ultimately even ingestion of the data into a production database if these controls pass.

In addition, human support personnel and/or processes can be brought into the loop to inspect the artifacts produced by the autonomous AI-agent prior to approving the next step in the flow. Before, after, or wholly instead of the human, additional base LLMs or AI-agents could be used to check the output of the main AI-agent (an AI-agent as a “control”). Through the limitations presented to the LLM-based agent engine 302 and the controls built on top and at the end of the execution of the LLM-based agent engine 302, risks associated with the use of such AI can be mitigated.

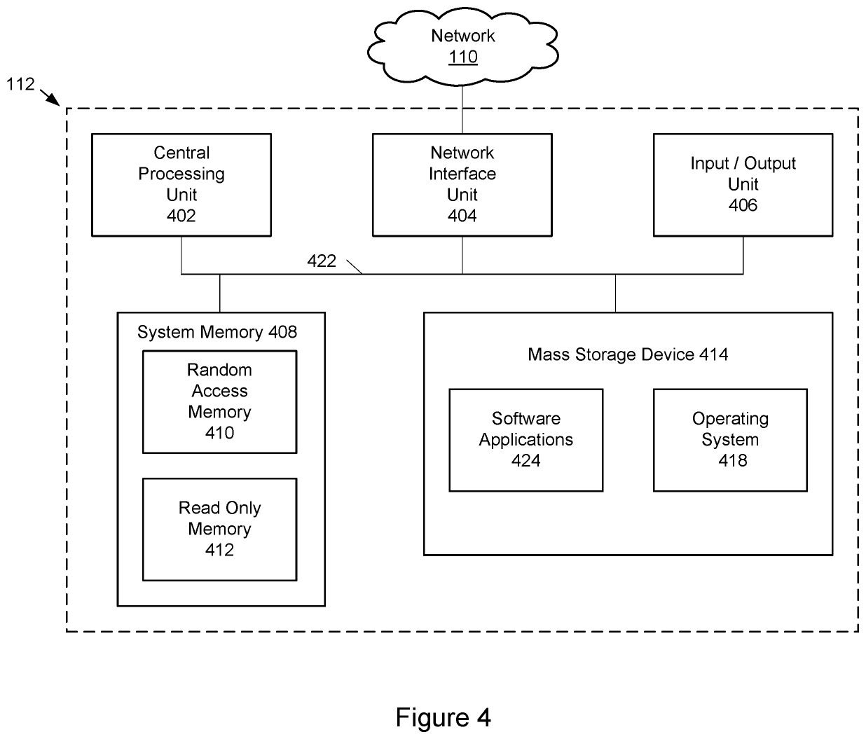

As illustrated in the embodiment of FIG. 4, the example server device 112, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for providing one or more tools for large language model agents, the computer system comprising:
one or more processors; and
non-transitory computer-readable storage media encoding instructions which, when executed by the one or more processors, causes the computer system to:
authenticate a user;
provide a description of the one or more tools available for use by the large language model agents;
execute the one or more tools upon receipt of a request from the large language model agents; and
provide information in response to the request.

2. The computer system of claim 1, wherein the user is authenticated by a third party.

3. The computer system of claim 1, wherein the description of the one or more tools includes a name and a use for each of the tools.

4. The computer system of claim 1, wherein the request generated through a prompt executed by the large language model agents.

5. The computer system of claim 1, wherein the one or more tools are related to financial accounts.

6. The computer system of claim 5, wherein the one or more tools include a tool to obtain balances for the financial accounts.

7. The computer system of claim 1, comprising further instructions which, when executed by the one or more processors, causes the computer system to provide an application programming interface to interface with the large language model agents.

8. The computer system of claim 7, wherein the application programming interface requires the user to be authenticated before providing the information to the large language model agents.

9. The computer system of claim 1, comprising further instructions which, when executed by the one or more processors, causes the computer system to intercept calls by the large language model agents.

10. The computer system of claim 9, wherein the intercept requires manual approval before the large language model agents are allowed to proceed.

11. A method for providing one or more tools for large language model agents, the method comprising:
authenticating a user;
providing a description of the one or more tools available for use by the large language model agents;
executing the one or more tools upon receipt of a request from the large language model agents; and
providing information in response to the request.

12. The method of claim 11, wherein the user is authenticated by a third party.

13. The method of claim 11, wherein the description of the one or more tools includes a name and a use for each of the tools.

14. The method of claim 11, wherein the request generated through a prompt executed by the large language model agents.

15. The method of claim 11, wherein the one or more tools are related to financial accounts.

16. The method of claim 15, wherein the one or more tools include a tool to obtain balances for the financial accounts.

17. The method of claim 11, further comprising providing an application programming interface to interface with the large language model agents.

18. The method of claim 17, wherein the application programming interface requires the user to be authenticated before providing the information to the large language model agents.

19. The method of claim 11, further comprising intercepting calls by the large language model agents.

20. The method of claim 19, wherein the intercepting requires manual approval before the large language model agents are allowed to proceed.
